(19) United States
(12) Patent Application Publication
(10) Pub. No.: US 2023/0185777 A1
(43) Pub. Date: Jun. 15, 2023

(54) NO-CODE RULES ENGINE TO BUILD NEAR REAL-TIME DATA PROJECTIONS FROM DISPARATE DATA SOURCES

(71) Applicant: INTUIT INC., Mountain View, CA (US)

(72) Inventors: Amit MATETY, San Diego, CA (US); Chau NGUYEN, Poway, CA (US); Harshavardhan SRINIVASAN, San Diego, CA (US)

(21) Appl. No.: 17/643,469

(22) Filed: Dec. 9, 2021

(51) Int. Cl. G06F 16/21; G06N 5/02; G06F 16/901

(52) U.S. Cl. CPC G06F 16/211; G06N 5/025; G06F 16/9024

(57) ABSTRACT

Aspects of the present disclosure provide techniques for data projection. Embodiments include receiving a schema defining a data projection, wherein the schema references data items from a plurality of data sources. Embodiments include receiving, based on the schema, a plurality of data events related to the data projection. Embodiments include loading information associated with the plurality of data events into a graph database based on the schema. Embodiments include determining that one or more completeness rules associated with the schema are satisfied based on the information associated with the plurality of data events. Embodiments include providing, based on the determining that the one or more completeness rules associated with the schema are satisfied, the information associated with the plurality of data events from the graph database to a data projection object for consumption by one or more services.

### INTRODUCTION

Aspects of the present disclosure relate to techniques for generating data projections from multiple data sources, particularly allowing for the definitions of such data projections without requiring programming knowledge.

### BACKGROUND

Every year millions of people, businesses, and organizations around the world utilize software applications to assist with countless aspects of life. Many types of data may be generated and stored by various computing applications and components. In some cases, an application may retrieve data from multiple data sources, such as separate applications and/or computing devices, in order to provide data about particular subjects to users.

As data sources multiply, it may become difficult to locate and retrieve data from various sources in order to provide unified views of the data. Furthermore, as continuous updates are made to the data stored at the various data sources, it can be difficult for an application to ensure that it has the latest data from these sources. In certain conventional systems, custom code is used to allow an application to retrieve data from various data sources, such as utilizing data streaming functionality provided by the data sources. Custom code is generally used to connect two systems together, which may be referred to as point-to-point integration. In some cases, integrating multiple data sources with an application requires creation of custom code between numerous applications, systems, data, and devices. Custom code may be expensive and time-consuming to create and maintain, and requires programming knowledge.

Therefore, there is a need in the art for improved techniques of configuring applications to provide particular sets of data based on underlying data retrieved from multiple data sources.

### BRIEF SUMMARY

Certain embodiments provide a method for data projection. The method generally includes: receiving a schema defining a data projection, wherein the schema references data items from a plurality of data sources; receiving, based on the schema, a plurality of data events related to the data projection; loading information associated with the plurality of data events into a graph database based on the schema; determining that one or more completeness rules associated with the schema are satisfied based on the information associated with the plurality of data events; and providing, based on the determining that the one or more completeness rules associated with the schema are satisfied, the information associated with the plurality of data events from the graph database to a data projection object for consumption by one or more services.

Other embodiments provide a method for data projection. The method generally includes: receiving a schema defining a data projection, wherein the schema references data items from a plurality of data sources; receiving, based on the schema, a plurality of data events related to the data projection; loading, based on the schema, information associated with the plurality of data events into a graph database that comprises nodes and edges, wherein the nodes comprise values and the edges indicate relationships among the values; determining that one or more completeness rules associated with the schema are not satisfied based on the information associated with the plurality of data events; receiving, based on the schema, one or more additional data events related to the data projection; loading, based on the schema, additional information associated with the one or more additional data events into the graph database; determining that the one or more completeness rules associated with the schema are satisfied based on the additional information associated with the one or more additional data events; and providing, based on the determining that the one or more completeness rules associated with the schema are satisfied, the information associated with the plurality of data events and the additional information associated with the one or more additional data events from the graph database to a data projection object for consumption by one or more services.

Other embodiments provide a system comprising one or more processors and a non-transitory computer-readable medium comprising instructions that, when executed by the one or more processors, cause the system to perform a method. The method generally includes: receiving a schema defining a data projection, wherein the schema references data items from a plurality of data sources; receiving, based on the schema, a plurality of data events related to the data projection; loading information associated with the plurality of data events into a graph database based on the schema; determining that one or more completeness rules associated with the schema are satisfied based on the information associated with the plurality of data events; and providing, based on the determining that the one or more completeness rules associated with the schema are satisfied, the information associated with the plurality of data events from the graph database to a data projection object for consumption by one or more services.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts example components related to rule-based data projections.

FIG. 2 depicts an example user interface screen providing a data projection based on data from a plurality of data sources.

FIG. 3 depicts an example related to generating a data projection based on data from a plurality of data sources.

FIG. 4 depicts an example graph database related to rule-based data projections.

FIG. 5 depicts example operations for rule-based data projections.

FIG. 6 depicts an example processing system related to rule-based data projections.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for rule-based data projections that do not require the use of custom code.

According to certain embodiments, schemas are used to define data projections based on data from multiple data sources. A data projection generally refers to a particular set of data that is determined based on data from one or more data sources, and may involve applying rules, calculations, transformations, or other operations with respect to the data according to a definition of the data projection. A data projection may be defined, for example, by a developer or administrator of an application, and may specify the data items that are to be retrieved from one or more data sources, and any operations that are to be performed with respect to the retrieved data item in order to produce the data projection. In one example, a data projection is a set of data related to users of an application, and includes information about user account statuses, length of use of the application, statuses of any support tickets related to the users, and/or the like. A definition of the data projection indicates the data sources from which the relevant items of data are to be retrieved (e.g., services, databases, and/or the like), which items of data are to be retrieved, and how the items of data are to be used to produce the data projection, such as Boolean rules (e.g., determining whether a given user does or does not have any open support tickets), calculations (e.g., determining a user's length of use of the application by retrieving the user's date of account creation and subtracting it from the current date), transformations (e.g., converting a numerical account status into explanatory text based on rules), and/or the like.

A schema may be an extensible markup language (XML) file, such as written in a persistence specification language (PSL), that does not require the use of custom code and that provides a definition of a data projection. The schema for a data projection may reference schemas for each data source. For instance, a developer or administrator may provide a schema for each data source that indicates how to retrieve data from the data source and which data items to retrieve from the data source, as well as a schema for the data projection that references one or more schemas of data sources in order to identify which items of data from the data sources are to be used to produce the data projection. These schemas may be registered with a projections engine that creates objects based on the schemas.

An object may, for instance, be an artifact such as an Apache® Kafka® topic that is a category or feed name to which records are written and published. Producer applications write data to objects and consumer applications read data from the objects. Data sources may be producer applications with respect to data source objects, and may write requested data to the data source objects for consumption by the projections engine. The projections engine may be a producer application (and/or may be included within or associated with a producer application) that writes data to a data projection object based on data consumed from data source objects, and a service that consumes the data projection may be referred to as a consumer application with respect to the data projection object.

In some cases, a schema associated with a data projection defines one or more completeness rules for the data projection. A completeness rule indicates a condition that must be met in order for a complete data projection to be produced. For instance, a completeness rule for a data projection may indicate that a particular set of values must be received (e.g., the values that are considered essential to the data projection, which may be a subset of all of the values related to the data projection) before publishing data to the data projection object. Completeness rules may ensure that data projections are not generated prematurely, such as based on incomplete data.

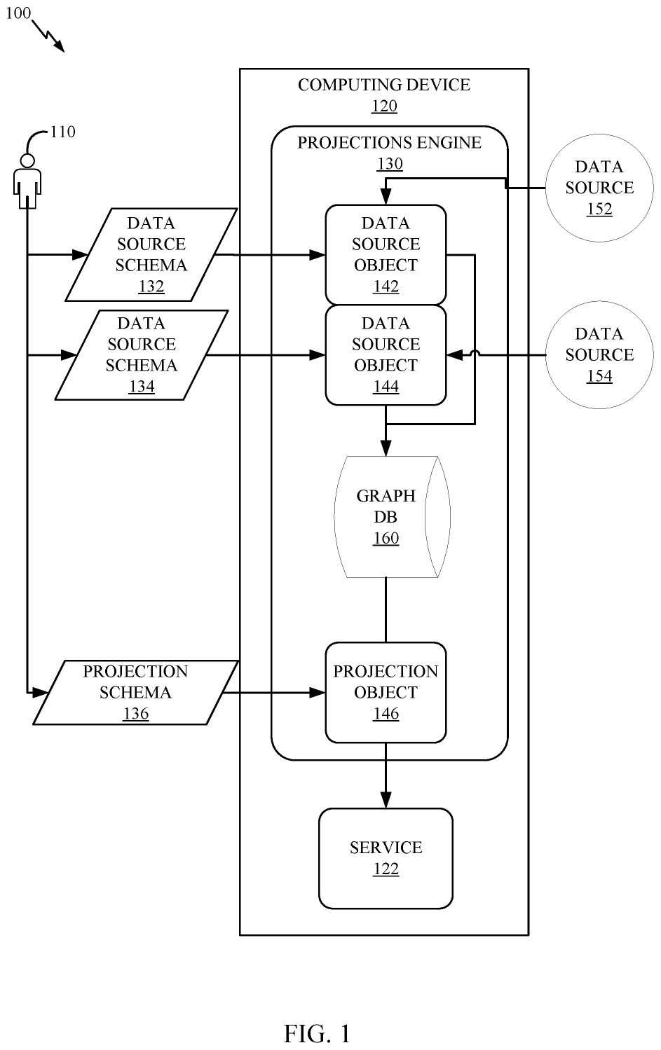

As described in more detail below with respect to FIG. 1, the projections engine serves as a central orchestrator between data sources and consumer applications by creating data source objects to which the data sources publish data and then creating and publishing data to a data projection object, based on the data published to the data source objects, for consumption by the consumer applications.

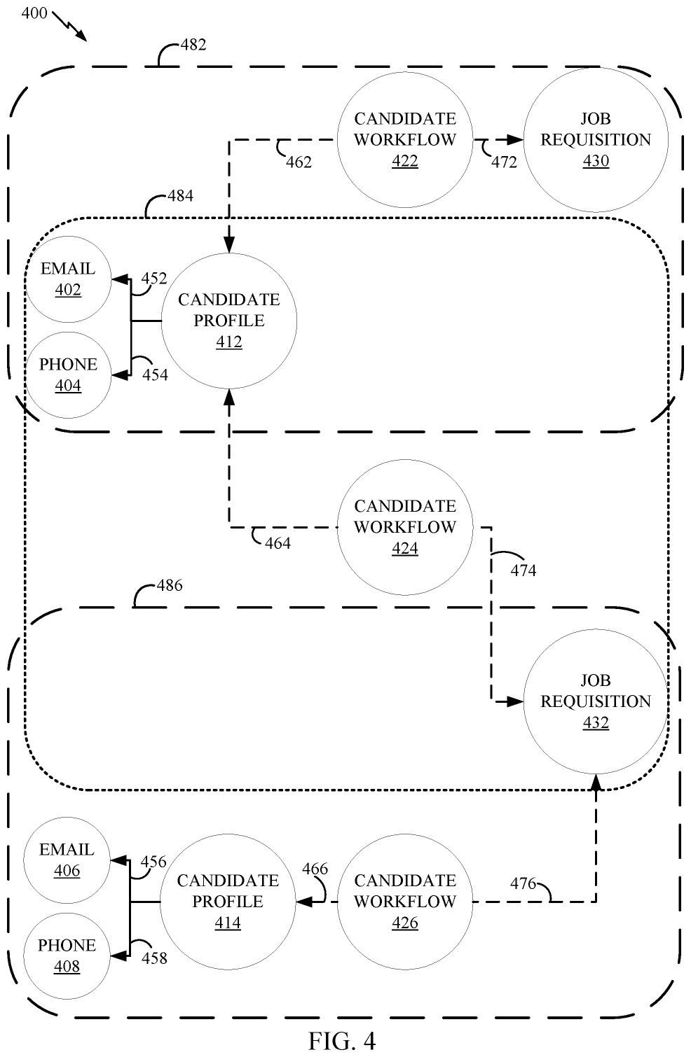

According to certain embodiments, as described in more detail below with respect to FIG. 4, the projections engine utilizes a graph database to store data received via data source objects in a relational manner. For example, as data items are published to data source objects by data sources, the projections engine receives the data items from the data source objects and loads them into a graph database along with relationship information indicating relationships among data items. In an example, the graph database includes nodes and edges with the nodes representing data items and the edges representing relationships among data items. Relationships may be explicit (e.g., for data items that are related in the underlying data sources, such as an email address being related to a particular user) and implicit (e.g., for data items that are related by other means, such as a data item from a first data source that was created by a user that is represented by a data item in a second data source). The graph database may function as a long-lived cache for data received from data sources so that the data may be efficiently retrieved along with relationship information for use in publishing data to data projections objects.

Embodiments of the present disclosure improve upon existing data projection techniques in a variety of ways. For example, unlike techniques that require the use of custom code, embodiments described herein can be efficiently implemented without time-consuming and expensive coding processes, allowing data projections to be defined instead through the use of schemas. Furthermore, techniques described herein allow data projections to be efficiently defined based on multiple underlying data sources rather than a single data source, and allow data from the multiple data sources to be transformed as appropriate based on rules that are efficiently defined within schemas.

Additionally, the use of a graph database as described herein allows the projections engine to handle data events that come out of order, with substantial delays, change gradually over time, or involve dependencies among multiple downstream data sources, by storing data items in a relational manner as they are received for long-lived access. Thus, the projections engine can gradually receive and build information needed to generate data projections, and can provide a data projection as soon as the requisite information is available. Completeness rules associated with data projections as described herein further improve upon data projection techniques by ensuring that incomplete data projections are not provided, thereby avoiding the unnecessary utilization of computing resources associated with generating, transmitting, and displaying incomplete data projections.

While schemas, graph databases, and other components of the present disclosure each involve various benefits individually (e.g., as described above), the combination of these components described herein provides additional benefits beyond the sum of the benefits provided by each individual component. For example, beyond providing the efficiency of schemas as compared to custom code and the longevity and relational storage benefits of graph databases, the particular combination of these components described herein further enables relationships among data items from multiple sources, including relationships that are not explicitly included in the underlying data sources, that are determined based on schemas to be stored via a graph database for use in generating data projections, such as allowing data projections to reflect dependencies among data from multiple data sources.

### Example Computing Components for Rule-Based Data Projections

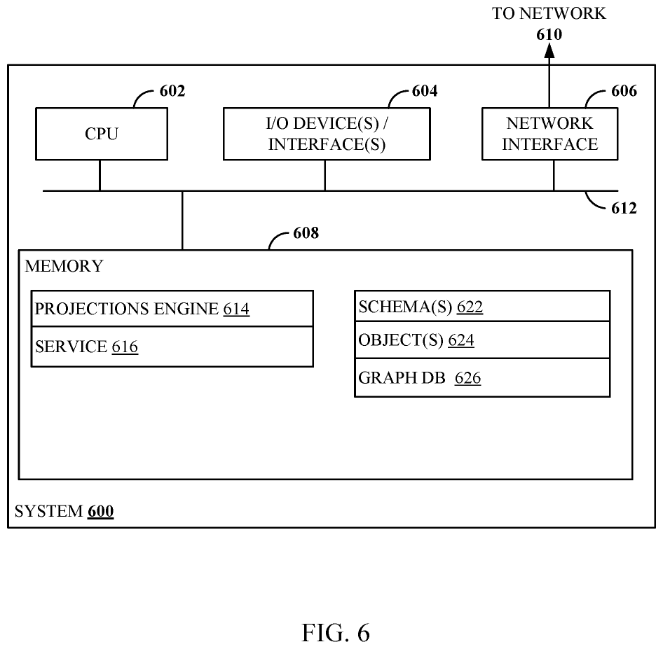

FIG. 1 is an illustration 100 of an example related to rule-based data projections. Illustration 100 includes a computing device 120 (e.g., which may represent one or more computing devices, as described in more detail below with respect to FIG. 6), data sources 152 and 154 (which may represent computing devices and/or software components such as services), and a user 110 that provides schemas 132, 134, and 136 to computing device 120.

Computing device 120 generally represents a computing device such as a server computer that runs one or more software components including projections engine 130 and service 122. In alternative embodiments, computing device 120 may represent one or more cloud computing devices. Service 122 may be a software application that utilizes one or more data projections provided by projections engine 130.

Projections engine 130 generally represents a component that performs certain operations described herein related to rule-based data projection. For example, projections engine 130 receives data source schemas 132 and 134 and projection schema 136 from user 110, and generates data source objects 142 and 144 and projection object 134 based on these schemas. Data source schemas 132 and 134 and projection schema 136 may be, for example, XML, files, such as PSL XML files. In one embodiment, data source schemas 132 and 134 comprise, respectively, identifying information of data sources 152 and 154 (e.g., identifiers, addresses, or other means of connecting to data sources 152 and 154) and indications of particular data items from data sources 152 and 154. In some embodiments, data source schemas 132 and 134 also include one or more operations to perform with respect to the data items, such as calculations, rules, transformations, summaries, and/or the like. For example, data source schema 132 may include a calculation of the total number of users that meet one or more conditions (e.g., having a certain type of account) based on user account information stored in data source 152.

Projection schema 136 may reference aspects of data source schemas 132 and/or 134 in defining a data projection. For example, projection schema 136 may include the total number of users meeting the one or more conditions from data source schema 132 as well as purchase history of those users from data source schema 134 (e.g., based on user activity information stored in data source 154). In some embodiments, schemas 132, 134, and 136 are registered with projections engine 130 by user 110 (e.g., a developer). Registering a schema may involve loading the schema into projections engine 130, such as via an application programming interface (API) provided by projections engine 130 or via a user interface associated with projections engine 130.

Data source objects 142 and 144 may be, for example, Kafka® topics to which data is published by data sources 152 and 154. For instance, projections engine may create data source objects 142 and 144 based on data source schemas 132 and 134, and may subscribe to data sources 152 and 154 so that relevant data is published by data sourced 152 and 154 to data source objects 142 and 144.

Data received by projections engine 130 via data source objects 142 and 144 may be stored in a graph database 160 along with relationship information about the data. For example, whenever a data item is published by data source 152 or 154 to data source object 142 or 144, projections engine 130 may store the data item in graph database 160 along with any relationship information of the data item with respect to other data items stored in graph database 160. In an example, data source 152 publishes a username to data source object 142 and data source 154 publishes an activity record of the user corresponding to the username to data source object 144. Projections engine 130 stores the username in a first node of graph database 160, stores the activity record in a second node of graph database 160, and adds an edge between the first node and the second node indicating that the activity record corresponds to an activity performed by the user corresponding to the username.

Projections engine 130 creates projection object 146 (e.g., another Kafka® topic) based on projection schema 136. Projections engine 130 may then publish data to projection object 146 from graph database 160. For example, if projection schema 136 defines a data projection that includes the purchase history of all users having a certain type of account and the total number of such users, then projections engine 130 retrieves these values from graph database 160 and publishes them to projection object 146. In some cases, projection schema 136 includes one or more completeness rules. For example, a completeness rule may specify that a data projection is only to be generated if there is at least one user having the certain type of account and that has made at least one purchase. Thus, if the current total number of users having the certain type of account, as reflected by the data stored in graph database 160, is zero or if there are no purchases recorded for any such users, as reflected by the data stored in graph database 160, then projections engine 130 may wait to publish such data to projection object 146 until the completeness rule is satisfied (e.g., once additional data comes in from data sources 152 and/or 154 indicating that there is at least one user meeting the condition with at least one purchase record).

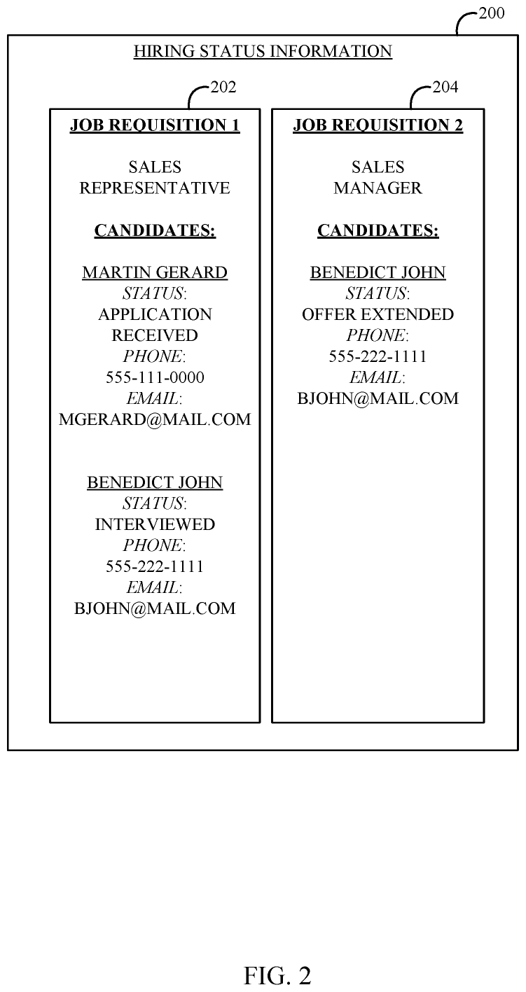

Service 122 consumes data projections from projection object 146, such as by calling an application programming interface (API) associated with projection object 146 to receive data published to projection object 146. Thus, when a data projection is published to projection object 146, service 122 receives the data projection. Service 122 may display the data projection via a user interface (e.g., as described below with respect to FIG. 2) and/or perform one or more other operations with respect to the data projection. For instance, service 122 may determine whether to recommend one or more products or services to users based on purchases made by the users indicated in a data projection received from projection object 146.

In one example, data sources 152 and 154 are microservices in a microservice-based deployment of an application. Microservices may generally refer to a collection of discrete applications that perform particular subsets of functionality of a larger software application. Projections engine 130 and/or service 122 may also be microservices in the microservice-based deployment, or may be separate components.

### Example User Interface Screen Related to Rule-Based Data Projection

FIG. 2 is an illustration of an example user interface screen 200 providing a data projection based on data from a plurality of data sources.

Screen 200 comprises a user interface related to a software application that displays information related to hiring statuses of candidates for job requisitions. For example, the information displayed in screen 200 may correspond to a data projection as described herein, such as provided by projections engine 130 of FIG. 1.

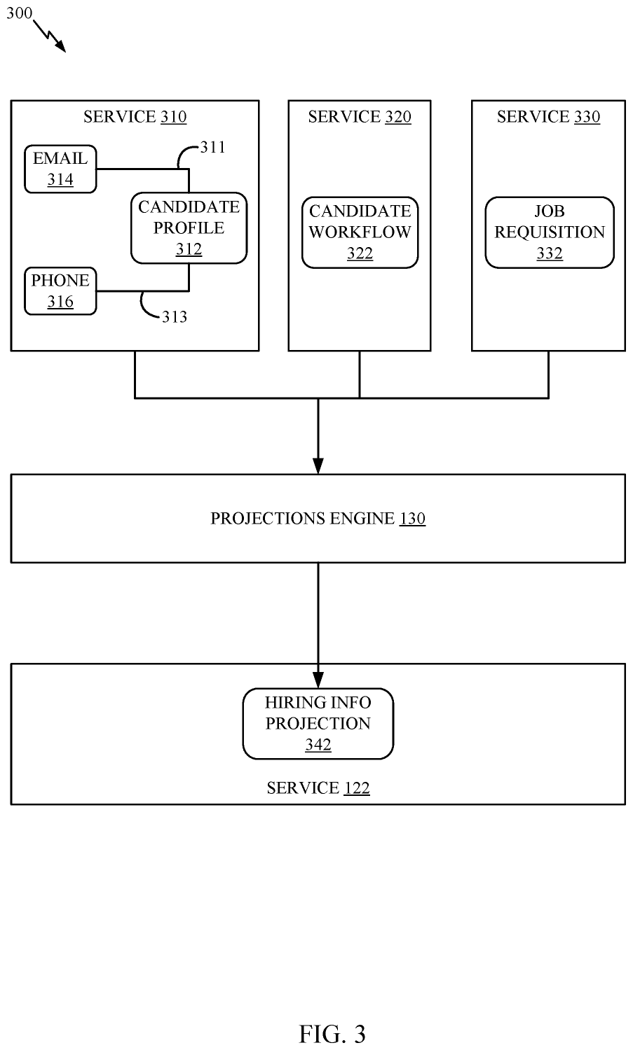

Screen 200 includes two panels 202 and 204 corresponding to different job requisitions. In an example, as described below with respect to FIG. 3, the data displayed in panels 202 and 204 is based on data from three different data sources (e.g., a first data source including candidate profiles, a second data source including candidate workflows with respect to job requisitions, and a third data source including the job requisitions).

Panel 202 includes the title of a first job requisition, “sales representative,” along with information about two candidates for the job. The first candidate, Martin Gerard, has a status of “application received,” a phone number of “555-111-0000,” and an email address of “mgerard@mail.com.” The second candidate, Benedict John, has a status of “interviewed,” a phone number of “555-222-1111,” and an email address of “bjohn@mail.com.”

Panel 204 includes the title of a second job requisition, “sales manager,” along with information about one candidate for the job. The candidate, Benedict John, has a status of “offer extended,” a phone number of “555-222-1111,” and an email address of “bjohn@mail.com.”

As described in more detail below with respect to FIG. 3, the data displayed in screen 200 may be a representation of a data projection that is generated based on data from multiple underlying data sources according to one or more schemas, such as schemas 132, 134, and 136 of FIG. 1.

### Example Data Projection Generation

FIG. 3 is an illustration 300 of an example related to generating a data projection based on data from a plurality of data sources. Illustration 300 includes projections engine 130 and service 122 of FIG. 1

Services 310, 320, 330 represent data sources similar to data sources 152 and 154 of FIG. 1. For example, services 310, 320, and 330 may be microservices that relate to specific aspects of an application that performs functionality related to managing recruiting and hiring for an organization. For example, service 310 may handle operations related to candidate profiles (e.g., information about candidates for jobs), service 320 may handle operations related to tracking candidate workflows (e.g., through stages of the recruiting process), and service 330 may handle operations related to job requisitions.

Service 310 comprises a candidate profile 312 of a candidate that is related via relationships 311 and 313 to an email address 314 and a phone number 316 of the candidate, respectively. Relationships 311 and 313 signify that email address 314 and phone number 316, respectively, are attributes of candidate profile 312.

Service 320 comprises a candidate workflow 322, which may include information related to the status of a candidate (e.g., corresponding to candidate profile 312) with respect to the hiring process for a particular job requisition (e.g., job requisition 332).

Service 330 comprises a job requisition 332, which may include details of a job for which candidates are being considered.

Data from services 310, 320, and 330 is provided to projections engine 130, such as being published to data source objects created by projections engine 130 based on data source schemas, as described above with respect to FIG. 1. Projections engine 130 may store the received data in a graph database, as described in more detail below with respect to FIG. 4 for use in generating a data projection. For example, projections engine 130 may publish data from the graph database to a projection object created based on a projection schema once one or more completeness rules included in the projection schema are satisfied, as described above with respect to FIG. 1.

Service 122 receives hiring information projection 342, such as from the projection object to which projections engine 130 publishes data. For example, service 122 may display hiring information projection 342 via a user interface as described above with respect to FIG. 3 and/or may perform other operations with respect to hiring information projection 342 (e.g., determining whether to notify one or more entities based on information included in hiring information projection 342).

### Example Graph Database

FIG. 4 is an illustration 400 of an example graph database related to rule-based data projections. For example, the graph database depicted in illustration 400 may correspond to graph database 160 of FIG. 1.

The graph database depicted in illustration 400 includes a plurality of nodes that store data items and a plurality of edges that store relationship information with respect to the nodes. Nodes 430 and 432 store data related to job requisitions and nodes 422, 424, and 426 store data related to candidate workflows (e.g., indicating statuses of particular candidates with respect to the job requisitions). Edges 472, 474, and 476 store relationship information indicating that the candidate workflows represented by nodes 422, 444, and 426 were created for job requisitions 430 and 432. In particular, edge 472 indicates that the candidate workflow represented by node 422 was created for the job requisition represented by node 430 and edges 474 and 476 indicate that the candidate workflows represented by nodes 424 and 426 were created for the job requisition represented by node 432.

Nodes 412 and 414 store data related to candidate profiles for particular job candidates. Edges 462 and 464 indicate that candidate workflows 422 and 424 were created for candidate profile 412, and edge 466 indicates that candidate workflow 426 was created for candidate profile 414. Edges 452 and 454 indicate that email 402 and phone 404, respectively, are part of candidate profile 412, and edges 456 and 458 indicate that email 406 and phone 408, respectively, are part of candidate profile 414. Emails 402 and 406 may be email addresses of candidates, while phones 404 and 408 may be phone numbers of candidates.

In some embodiments, edges 452, 454, 456, and 458 represent explicit relationships because they are based on relationships that are present in the underlying data source (e.g., the email addresses and phone numbers are part of the candidate profiles in the data source), while edges 462, 464, 466, 472, 474, and 476 represent implicit relationships because they are based on relationships between separate data sources. For example, an implicit relationship may be referred to as a “foreign key” relationship, as one data source may reference a data item (e.g., by a key such as an identifier) in another data source (e.g., a foreign data source). In a particular example, candidate workflow 422 in a first data source may include a foreign key that references job requisition 430 in a second data source and another foreign key that references candidate profile 412 in a third data source.

Boxes 482, 484, and 486 are representative of data projections. In particular, box 482 represents a data projection that includes data about candidate workflow 422 for job requisition 430 with respect to candidate profile 412, box 484 represents a data projection that includes data about candidate workflow 424 for job requisition 432 with respect to candidate profile 412, and box 486 represents a data projection that includes data about candidate workflow 426 for job requisition 432 with respect to candidate profile 414. Each of the data projections represented by boxes 482, 484, and 486 includes an email address and phone number of a single candidate and information about that candidate's workflow with respect to a particular job requisition.

The relational information stored in the graph database represented by illustration 400 allows data projections to be defined and generated over time as relevant information becomes available from various data sources and is stored by a projections engine in the graph database (e.g., which acts as a long-lived cache of information related to data projections).

### Example Operations for Rule Based Data Projection

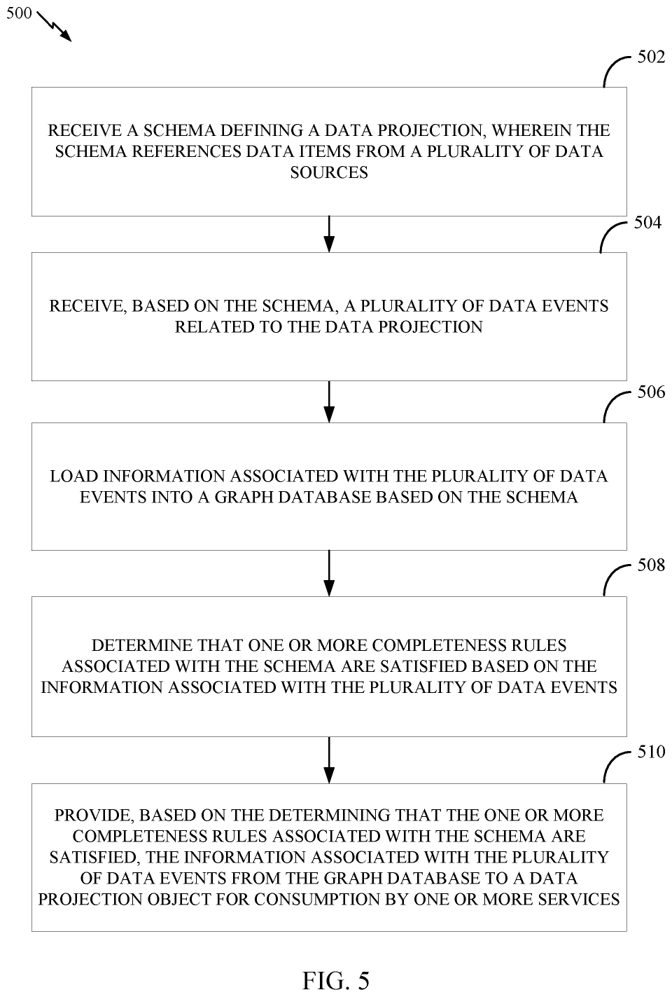

FIG. 5 depicts example operations 500 related to rule-based data projection. For example, operations 500 may be performed by one or more components of a computing device 120 of FIG. 1.

Operations 500 begin at step 502, with receiving a schema defining a data projection, wherein the schema references data items from a plurality of data sources. In some embodiments, the schema comprises a persistence specification language (PSL) file, such as an extensible markup language (XML) PSL file. Certain embodiments further comprise receiving a plurality of schemas corresponding to the plurality of data sources.

Operations 500 continue at step 504, with receiving, based on the schema, a plurality of data events related to the data projection.

In some embodiments, receiving, based on the schema, the plurality of data events related to the data projection comprises creating a plurality of objects for receiving data events from the plurality of data sources based on the plurality of schemas and receiving the plurality of data events via the plurality of objects.

Operations 500 continue at step 506, with loading information associated with the plurality of data events into a graph database based on the schema. In certain embodiments, the graph database comprises nodes and edges, wherein the nodes comprise values and the edges indicate relationships among the values. Some embodiments further comprise performing one or more calculations or transformations based on the plurality of data events according to instructions in the schema.

Operations 500 continue at step 508, with determining that one or more completeness rules associated with the schema are satisfied based on the information associated with the plurality of data events. Certain embodiments further comprise receiving an additional schema comprising the one or more completeness rules.

Operations 500 continue at step 510, with providing, based on the determining that the one or more completeness rules associated with the schema are satisfied, the information associated with the plurality of data events from the graph database to a data projection object for consumption by one or more services. For example, the data projection object may provide a data stream related to the data projection to the one or more services in response to one or more requests from the one or more services.

Some embodiments further comprise determining that one or more completeness rules associated with the schema are not satisfied based on the information associated with the plurality of data events. These embodiments may further comprise receiving, based on the schema, one or more additional data events related to the data projection, loading, based on the schema, additional information associated with the one or more additional data events into the graph database, and determining that the one or more completeness rules associated with the schema are satisfied based on the additional information associated with the one or more additional data events. For example, based on the determining that the one or more completeness rules associated with the schema are satisfied, the information associated with the plurality of data events and the additional information associated with the one or more additional data events from the graph database may be provided to a data projection object for consumption by one or more services.

Notably, operations 500 is one example with a selections of example steps, but other embodiments with more, fewer, and/or different steps, and/or steps performed in a different order, are possible based on the disclosure herein.

### Example Computing Systems

FIG. 6 illustrates an example system 600 with which embodiments of the present disclosure may be implemented. For example, system 600 may correspond to computing device 120 of FIG. 1, and may be configured to perform operations 500 of FIG. 5.

System 600 includes a central processing unit (CPU) 602, one or more I/O device interfaces 604 that may allow for the connection of various I/O devices (e.g., keyboards, displays, mouse devices, pen input, etc.) to the system 600A, network interface 606, a memory 608, and an interconnect 612. It is contemplated that one or more components of system 600 may be located remotely and accessed via a network 610. It is further contemplated that one or more components of system 600A may comprise physical components or virtualized components.

CPU 602 may retrieve and execute programming instructions stored in the memory 608. Similarly, the CPU 602 may retrieve and store application data residing in the memory 608. The interconnect 612 transmits programming instructions and application data, among the CPU 602, I/O device interface 604, network interface 606, and memory 608. CPU 602 is included to be representative of a single CPU, multiple CPUs, a single CPU having multiple processing cores, and other arrangements.

Additionally, the memory 608 is included to be representative of a random access memory or the like. In some embodiments, memory 608 may comprise a disk drive, solid state drive, or a collection of storage devices distributed across multiple storage systems. Although shown as a single unit, the memory 608 may be a combination of fixed and/or removable storage devices, such as fixed disc drives, removable memory cards or optical storage, network attached storage (NAS), or a storage area-network (SAN).

As shown, memory 608 includes projection engine 614 and service 616, which may be representative of projections engine 130 and service 122 of FIG. 1.

Memory 608 further comprises schema(s) 622, which may include data source schemas 132 and 134 and projection schema 135 of FIG. 1. Memory 608 further comprises object(s) 624, which may include data source objects 142 and 144 and projection object 146 of FIG. 1. Memory 608 further comprises graph database 626, which may be representative of graph database 160 of FIG. 1.

### Example Clauses

Clause 1: A method for data projection, comprising: receiving a schema defining a data projection, wherein the schema references data items from a plurality of data sources; receiving, based on the schema, a plurality of data events related to the data projection; loading information associated with the plurality of data events into a graph database based on the schema; determining that one or more completeness rules associated with the schema are satisfied based on the information associated with the plurality of data events; and providing, based on the determining that the one or more completeness rules associated with the schema are satisfied, the information associated with the plurality of data events from the graph database to a data projection object for consumption by one or more services.

Clause 2: The method of Clause 1, further comprising receiving a plurality of schemas corresponding to the plurality of data sources, wherein the schema references the data items from the plurality of data sources by referencing components of the plurality of schemas.

Clause 3: The method of any of Clause 1-2, wherein receiving, based on the schema, the plurality of data events related to the data projection comprises: creating a plurality of objects for receiving data events from the plurality of data sources based on the plurality of schemas; and receiving the plurality of data events via the plurality of objects.

Clause 4: The method of any of Clause 1-3, further comprising performing one or more calculations or transformations based on the plurality of data events according to instructions in the schema.

Clause 5: The method of any of Clause 1-4, further comprising receiving an additional schema defining the one or more completeness rules.

Clause 6: The method of any of Clause 1-5, wherein the data projection object provides a data stream related to the data projection to the one or more services in response to one or more requests from the one or more services.

Clause 7: The method of any of Clause 1-6, wherein the schema comprises a persistence specification language (PSL) file.

Clause 8: A method for data projection, comprising: receiving a schema defining a data projection, wherein the schema references data items from a plurality of data sources; receiving, based on the schema, a plurality of data events related to the data projection; loading, based on the schema, information associated with the plurality of data events into a graph database that comprises nodes and edges, wherein the nodes comprise values and the edges indicate relationships among the values; determining that one or more completeness rules associated with the schema are not satisfied based on the information associated with the plurality of data events; receiving, based on the schema, one or more additional data events related to the data projection; loading, based on the schema, additional information associated with the one or more additional data events into the graph database; determining that the one or more completeness rules associated with the schema are satisfied based on the additional information associated with the one or more additional data events; and providing, based on the determining that the one or more completeness rules associated with the schema are satisfied, the information associated with the plurality of data events and the additional information associated with the one or more additional data events from the graph database to a data projection object for consumption by one or more services.

Clause 9: The method of Clause 8, further comprising receiving a plurality of schemas corresponding to the plurality of data sources, wherein the schema references the data items from the plurality of data sources by referencing components of the plurality of schemas.

Clause 10: The method of any of Clause 8-9, wherein receiving, based on the schema, the plurality of data events related to the data projection comprises: creating a plurality of objects for receiving data events from the plurality of data sources based on the plurality of schemas; and receiving the plurality of data events via the plurality of objects.

Clause 11: The method of any of Clause 8-10, further comprising performing one or more calculations or transformations based on the plurality of data events according to instructions in the schema.

Clause 12: The method of any of Clause 8-11, further comprising receiving an additional schema defining the one or more completeness rules.

Clause 13: The method of any of Clause 8-12, wherein the data projection object provides a data stream related to the data projection to the one or more services in response to one or more requests from the one or more services.

Clause 14: The method of any of Clause 8-13, wherein the schema comprises a persistence specification language (PSL) file.

Clause 15: A system, comprising: one or more processors; and a memory comprising instructions that, when executed by the one or more processors, cause the system to: receive a schema defining a data projection, wherein the schema references data items from a plurality of data sources; receive, based on the schema, a plurality of data events related to the data projection; load information associated with the plurality of data events into a graph database based on the schema; determine that one or more completeness rules associated with the schema are satisfied based on the information associated with the plurality of data events; and provide, based on the determining that the one or more completeness rules associated with the schema are satisfied, the information associated with the plurality of data events from the graph database to a data projection object for consumption by one or more services.

Clause 16: The system of Clause 15, wherein the instructions, when executed by the one or more processors, further cause the system to receive a plurality of schemas corresponding to the plurality of data sources, wherein the schema references the data items from the plurality of data sources by referencing components of the plurality of schemas.

Clause 17: The system of any of Clause 15-16, wherein receiving, based on the schema, the plurality of data events related to the data projection comprises: creating a plurality of objects for receiving data events from the plurality of data sources based on the plurality of schemas; and receiving the plurality of data events via the plurality of objects.

Clause 18: The system of any of Clause 15-17, wherein the instructions, when executed by the one or more processors, further cause the system to perform one or more calculations or transformations based on the plurality of data events according to instructions in the schema.

Clause 19: The system of any of Clause 15-18, wherein the instructions, when executed by the one or more processors, further cause the system to receive an additional schema defining the one or more completeness rules.

Clause 20: The system of any of Clause 15-19, wherein the data projection object provides a data stream related to the data projection to the one or more services in response to one or more requests from the one or more services.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for data projection, comprising:
receiving a schema defining a data projection, wherein the schema references data items from a plurality of data sources;
receiving, based on the schema, a plurality of data events related to the data projection;
loading information associated with the plurality of data events into a graph database based on the schema;
determining that one or more completeness rules associated with the schema are satisfied based on the information associated with the plurality of data events; and
providing, based on the determining that the one or more completeness rules associated with the schema are satisfied, the information associated with the plurality of data events from the graph database to a data projection object for consumption by one or more services.

2. The method of claim 1, further comprising receiving a plurality of schemas corresponding to the plurality of data sources, wherein the schema references the data items from the plurality of data sources by referencing components of the plurality of schemas.

3. The method of claim 1, wherein receiving, based on the schema, the plurality of data events related to the data projection comprises:
creating a plurality of objects for receiving data events from the plurality of data sources based on the plurality of schemas; and
receiving the plurality of data events via the plurality of objects.

4. The method of claim 1, further comprising performing one or more calculations or transformations based on the plurality of data events according to instructions in the schema.

5. The method of claim 1, further comprising receiving an additional schema defining the one or more completeness rules.

6. The method of claim 1, wherein the data projection object provides a data stream related to the data projection to the one or more services in response to one or more requests from the one or more services.

7. The method of claim 1, wherein the schema comprises a persistence specification language (PSL) file.

8. A method for data projection, comprising:
receiving a schema defining a data projection, wherein the schema references data items from a plurality of data sources;
receiving, based on the schema, a plurality of data events related to the data projection;
loading, based on the schema, information associated with the plurality of data events into a graph database that comprises nodes and edges, wherein the nodes comprise values and the edges indicate relationships among the values;
determining that one or more completeness rules associated with the schema are not satisfied based on the information associated with the plurality of data events;
receiving, based on the schema, one or more additional data events related to the data projection;
loading, based on the schema, additional information associated with the one or more additional data events into the graph database;
determining that the one or more completeness rules associated with the schema are satisfied based on the additional information associated with the one or more additional data events; and
providing, based on the determining that the one or more completeness rules associated with the schema are satisfied, the information associated with the plurality of data events and the additional information associated with the one or more additional data events from the graph database to a data projection object for consumption by one or more services.

9. The method of claim 8, further comprising receiving a plurality of schemas corresponding to the plurality of data sources, wherein the schema references the data items from the plurality of data sources by referencing components of the plurality of schemas.

10. The method of claim 8, wherein receiving, based on the schema, the plurality of data events related to the data projection comprises:
creating a plurality of objects for receiving data events from the plurality of data sources based on the plurality of schemas; and
receiving the plurality of data events via the plurality of objects.

11. The method of claim 8, further comprising performing one or more calculations or transformations based on the plurality of data events according to instructions in the schema.

12. The method of claim 8, further comprising receiving an additional schema defining the one or more completeness rules.

13. The method of claim 8, wherein the data projection object provides a data stream related to the data projection to the one or more services in response to one or more requests from the one or more services.

14. The method of claim 8, wherein the schema comprises a persistence specification language (PSL) file.

15. A system, comprising:
one or more processors; and
a memory comprising instructions that, when executed by the one or more processors, cause the system to:
receive a schema defining a data projection, wherein the schema references data items from a plurality of data sources;
receive, based on the schema, a plurality of data events related to the data projection;
load information associated with the plurality of data events into a graph database based on the schema;
determine that one or more completeness rules associated with the schema are satisfied based on the information associated with the plurality of data events; and
provide, based on the determining that the one or more completeness rules associated with the schema are satisfied, the information associated with the plurality of data events from the graph database to a data projection object for consumption by one or more services.

16. The system of claim 15, wherein the instructions, when executed by the one or more processors, further cause the system to receive a plurality of schemas corresponding to the plurality of data sources, wherein the schema references the data items from the plurality of data sources by referencing components of the plurality of schemas.

17. The system of claim 15, wherein receiving, based on the schema, the plurality of data events related to the data projection comprises:
creating a plurality of objects for receiving data events from the plurality of data sources based on the plurality of schemas; and
receiving the plurality of data events via the plurality of objects.

18. The system of claim 15, wherein the instructions, when executed by the one or more processors, further cause the system to perform one or more calculations or transformations based on the plurality of data events according to instructions in the schema.

19. The system of claim 15, wherein the instructions, when executed by the one or more processors, further cause the system to receive an additional schema defining the one or more completeness rules.

20. The system of claim 15, wherein the data projection object provides a data stream related to the data projection to the one or more services in response to one or more requests from the one or more services.
